(19) United States
(12) Patent Application Publication
(10) Pub. No.: US 2017/0094082 A1
(43) Pub. Date: Mar. 30, 2017

(54) INFORMATION PROCESSING APPARATUS, IMAGE FORMING APPARATUS, AND NON-TRANSITORY COMPUTER READABLE MEDIUM

(71) Applicant: FUJI XEROX CO., LTD., Tokyo (JP)

(72) Inventor: Jun ANDO, Kanagawa (JP)

(73) Assignee: FUJI XEROX CO., LTD., Tokyo (JP)

(21) Appl. No.: 15/044,527

(22) Filed: Feb. 16, 2016

(30) Foreign Application Priority Data
Sep. 25, 2015 (JP) 2015-187677

(51) Int. Cl. H04N 1/00

(52) U.S. Cl. CPC H04N 1/00411; H04N 1/00413; H04N 2201/0094; G06F 3/0482

(57) ABSTRACT

An information processing apparatus includes an acquiring unit that acquires service information items each of which is set to a corresponding one of display components, which are displayed on a service-selection screen and selected when running services, and each of which includes parameter values set for the corresponding service, an extracting unit that refers to one of the service information items which is associated with one of the display components selected on the service-selection screen as a result of performing a certain search-execution operation and that extracts services related to the one of the services, and a display controller that performs control in such a manner that the display components that are to be selected for running the extracted services are displayed on a related-service display screen.

### CROSS-REFERENCE TO RELATED APPLICATIONS

This application is based on and claims priority under 35 USC 119 from Japanese Patent Application No. 2015-187677 filed Sep. 25, 2015.

### BACKGROUND

(i) Technical Field

The present invention relates to an information processing apparatus, an image forming apparatus, and a non-transitory computer readable medium.

(ii) Related Art

A menu screen, which shows buttons (icons) corresponding to services, is displayed on an operation panel of a multifunction machine that provides various service functions or an operation panel of an expansion box that is to be attached to such a multifunction machine so that a user may easily run a desired service by selecting one of the buttons from the menu screen.

If a shortcut button, which enables a service function to run in a state where parameter values have previously been set, has been added to the menu screen, it is not necessary to set various parameter values each time of a service has started running, and accordingly, enhanced user convenience may be achieved.

### SUMMARY

According to an aspect of the invention, there is provided an information processing apparatus including an acquiring unit that acquires service information items each of which is set to a corresponding one of display components, which are displayed on a service-selection screen and selected when running services, and each of which includes parameter values set for the corresponding service, an extracting unit that refers to one of the service information items which is associated with one of the display components selected on the service-selection screen as a result of performing a certain search-execution operation and that extracts services related to the one of the services, and a display controller that performs control in such a manner that the display components that are to be selected for running the extracted services are displayed on a related-service display screen.

### BRIEF DESCRIPTION OF THE DRAWINGS

An exemplary embodiment of the present invention will be described in detail based on the following figures, wherein:

FIG. 1 is a block schematic diagram illustrating an image forming apparatus according to an exemplary embodiment of the present invention;

FIG. 2 is a diagram illustrating a hardware configuration of the image forming apparatus according to the exemplary embodiment of the present invention;

FIG. 3 is a diagram illustrating an example of a data configuration of service information according to the exemplary embodiment;

FIG. 4 is a flowchart illustrating service-selection processing according to the exemplary embodiment;

FIG. 5 is a diagram illustrating an example of a menu screen in which buttons are displayed according to the exemplary embodiment; and

FIG. 6 is a diagram illustrating a display example of a related-service display screen according to the exemplary embodiment.

### DETAILED DESCRIPTION

An exemplary embodiment of the present invention will be described below with reference to the drawings.

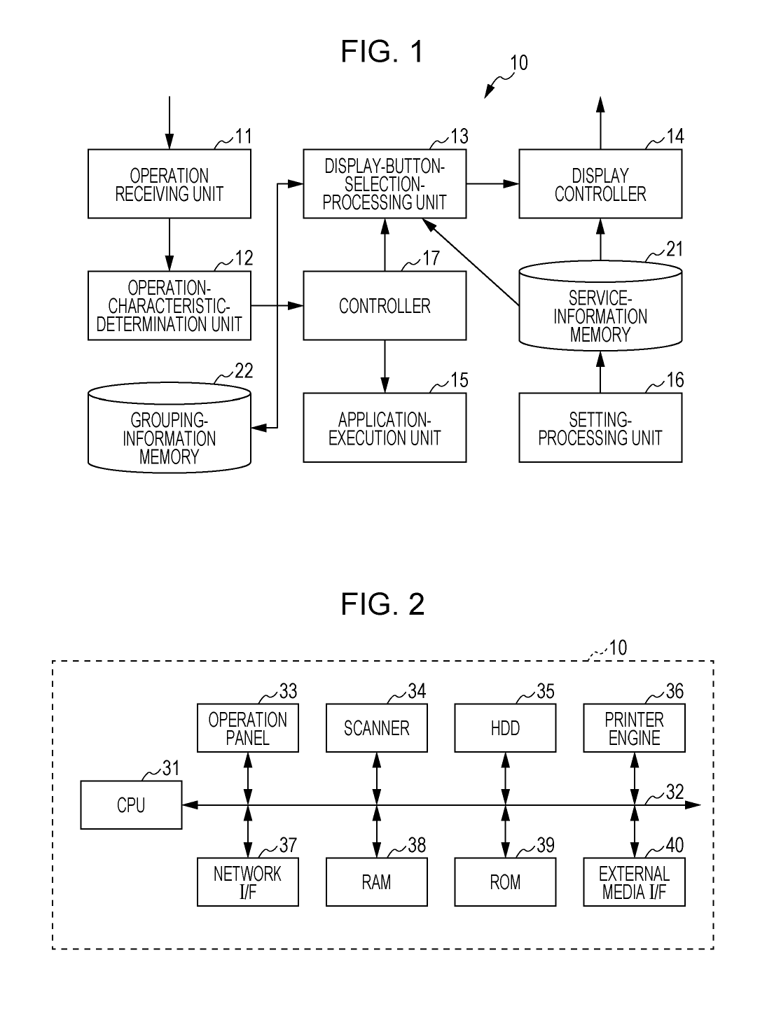

FIG. 1 is a block schematic diagram illustrating an image forming apparatus 10 according to the exemplary embodiment of the present invention. FIG. 2 is a diagram illustrating the hardware configuration of the image forming apparatus 10 according to the exemplary embodiment. The image forming apparatus 10 according to the exemplary embodiment is a multifunction machine that is provided with various service functions, such as a copy function and a scanner function, and is an apparatus with a built-in computer. In FIG. 2, a CPU 31 controls the operations of various devices such as a scanner 34 and a printer engine 36 that are mounted in the image forming apparatus 10 in accordance with programs stored in a ROM 39. An address data bus 32 is connected to the various devices, which are configured to be controlled by the CPU 31, and performs data communication with the various devices. An operation panel 33 performs display of information, such as a menu screen and a related-service display screen each of which will be described later, and receives an instruction from a user. The scanner 34 reads a document, which has been set by a user, and stores the document as electronic data in a hard disk drive (HDD) 35 or the like. An electronic document, which is read by the scanner 34, and the like are stored in the HDD 35. The printer engine 36 prints an image on an output sheet in accordance with an instruction from a control program that is executed by the CPU 31. A network interface (I/F) 37 connects the image forming apparatus 10 to a network and is used to transmit electronic data, which has been generated by the image forming apparatus 10, receive electronic mail, which is transmitted to the image forming apparatus 10, access the image forming apparatus 10 through a browser, and the like. A RAM 38 is used as a work memory at the time of executing a program or as a communication buffer for transmitting and receiving electronic data. Various programs that relate to control of the image forming apparatus 10, electronic data encryption, and transmission and reception of electronic data are stored in the ROM 39. As a result of the various programs being executed, each component, which will be described later, may realize a certain processing capability. An external media interface (I/F) 40 is an interface between the image forming apparatus 10 and an external memory device, such as a universal serial bus (USB) memory or a flash memory. The image forming apparatus 10 has the above-described configuration and provides various service functions. Note that, in the present exemplary embodiment, although the image forming apparatus 10 will be described as a discrete device for convenience of description, an expansion box or the like may be connected to the image forming apparatus 10 depending on the types and the specifications of the service functions provided by the image forming apparatus 10.

Returning to FIG. 1, the image forming apparatus 10 according to the present exemplary embodiment includes an operation-receiving unit 11, an operation-characteristic-determination unit 12, a display-button-selection-processing unit 13, a display controller 14, an application-execution unit 15, a setting processing unit 16, a controller 17, a service-information memory 21, and a grouping-information memory 22. Note that components that are not necessary for the description of the present exemplary embodiment are not illustrated in FIG. 1.

The operation-receiving unit 11 operates in cooperation with the operation panel 33 and receives operations performed by a user for the menu screen and the related-service display screen. The operation-characteristic-determination unit 12 determines, by analyzing an operation received by the operation-receiving unit 11, whether a certain search-execution operation has been performed. The display-button-selection-processing unit 13 functions as an acquiring unit and an extracting unit. When a button is selected on the menu screen as a result of performing a certain search-execution operation, the display-button-selection-processing unit 13 acquires service information items from the service-information memory 21 and extracts a service that is related to a service that is associated with the selected button on the basis of a service information item that is associated with the selected button. Note that, in the present exemplary embodiment, although buttons are used as display components on the menu screen, which are selected when running services, other display components may be used. As will be described later, after one of the buttons has been selected as a result of performing a certain search-execution operation, the display-button-selection-processing unit 13 extracts services that are related to a service that is associated with the selected button. In addition, the display-button-selection-processing unit 13 functions as a storing unit that generates grouping information regarding a group of buttons for running the extracted services and causes the grouping-information memory 22 to store the grouping information. The display controller 14 performs display control on the operation panel 33 in such a manner that, for example, the buttons for running the services, which have been extracted by the display-button-selection-processing unit 13, are displayed on the related-service display screen. The application-execution unit 15 executes an application that provides a service function selected by a user. The setting processing unit 16 functions as a setting unit that sets identification information of a group for the service information items of services that correspond to buttons included in the group. The controller 17 performs overall control of the image forming apparatus 10 by causing the above-described components, which are the operation-receiving unit 11, the operation-characteristic-determination unit 12, display-button-selection-processing unit 13, the display controller 14, the application-execution unit 15, and the setting processing unit 16, to operate in cooperation with one another. Here, the term “service” may refer to any service that provides a certain processing on the basis of a user request, and such services may be related to the functions provided by the image forming apparatus 10. Examples of scanning services include reading a sheet document by using the scanner 34, transmitting an image of the sheet document which has been read via electronic mail, transmitting the image of the sheet document which has been read, via fax and forwarding the image of the sheet document which has been read to a server. Another example of such a service may be execution of a service function that is provided by an external image forming apparatus (not illustrated) or an external server (not illustrated) by running the service provided by the external image forming apparatus or the external server.

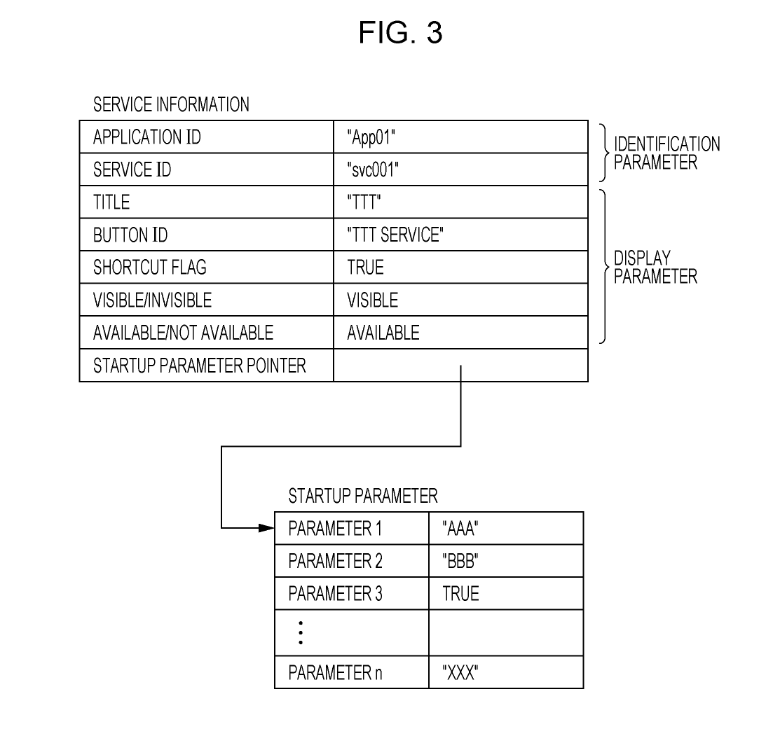

FIG. 3 is a diagram illustrating the overall configuration of a service information item stored in the service-information memory 21 according to the present exemplary embodiment. The service information item is set for each of the buttons displayed on the menu screen. As described above, each of the buttons is a display component that is selected by a user when running a service. Once the buttons have been generated, the corresponding service information items are generated and registered in the service-information memory 21. Parameter values that are classified into three types, which are an identification parameter, a display parameter, and a startup parameter, are set for each of the service information items.

Information items regarding the identification of services are set for the corresponding identification parameters. In the present exemplary embodiment, service IDs that identify corresponding services that are associated with the buttons and a common application ID that is assigned to each of the services whose types are similar to one another and that are processed by similar applications, are set. For example, the scanning services include “Scan”, “ScanToMail”, “ScanToFax”, and “ScanToServer”. Individual service IDs are assigned to these services, and a common application ID is assigned to each of the services.

Information items regarding the buttons, which are associated with the corresponding services and displayed on the menu screen, are set for the corresponding display parameters. For example, button IDs that identify the corresponding buttons, titles that describe the corresponding buttons, shortcut flags each of which indicates whether the corresponding button is a shortcut button, information items indicating whether the corresponding buttons are visible or invisible, information items indicating whether the corresponding buttons are available or not available, and the like are set.

Parameters that are passed to an application corresponding to one of the buttons when the button is selected on the menu screen are set for the startup parameters. Unlike the identification parameters and the display parameters, the contents and the number of the startup parameters differ depending on applications, and thus, the setting number of the startup parameters is variable. Although one of the parameter names is “parameter 1” in FIG. 3, for example, in the case of a scanning application, “document size”, “document orientation”, “single-sided/double-sided”, “color mode” and the like are set as the parameter names, and “A4”, “landscape”, “double-sided”, “monochrome”, and the like are set as the parameter values.

In the image forming apparatus 10, the operation-receiving unit 11, the operation-characteristic-determination unit 12, the display-button-selection-processing unit 13, the display controller 14, the application-execution unit 15, the setting processing unit 16, and the controller 17 are realized by a cooperative operation performed by the computer mounted in the image forming apparatus 10 and programs executed by the CPU 31 mounted in the computer. The service-information memory 21 and the grouping-information memory 22 are realized by the HDD 35 mounted in the image forming apparatus 10. Alternatively, the RAM 38 or an external memory may be used via a network in order to realize the service-information memory 21 and the grouping-information memory 22.

The programs that are used in the present exemplary embodiment may be provided by being stored in a computer-readable recording medium, such as a CD-ROM or a USB memory, as well as may be provided by a communication unit. The programs provided by such a communication unit or such a recording medium are installed in the computer, and the CPU 31 of the computer sequentially executes the programs, so that various processing operations are realized.

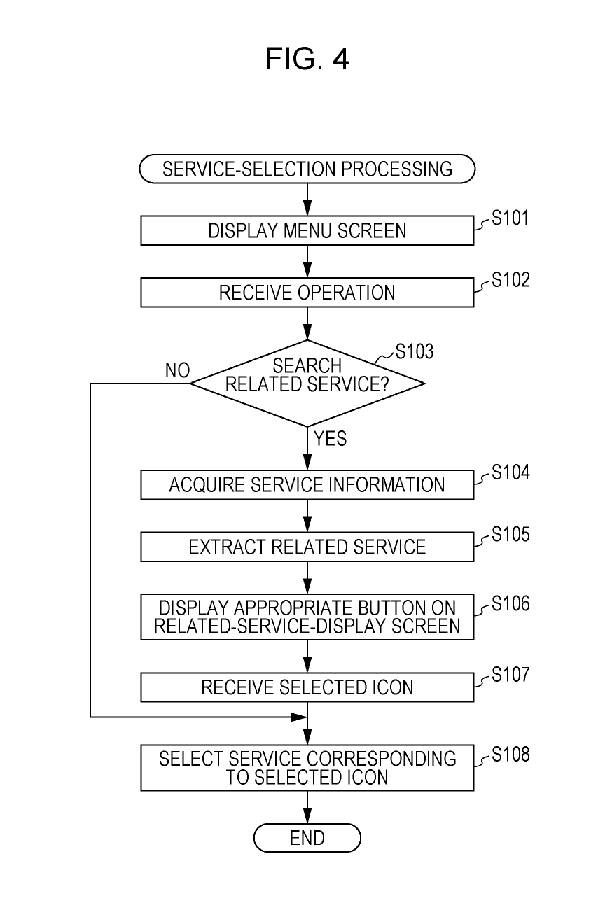

Processing for selecting a service that is desired to be used by a user in the present exemplary embodiment will now be described with reference to the flowchart illustrated in FIG. 4.

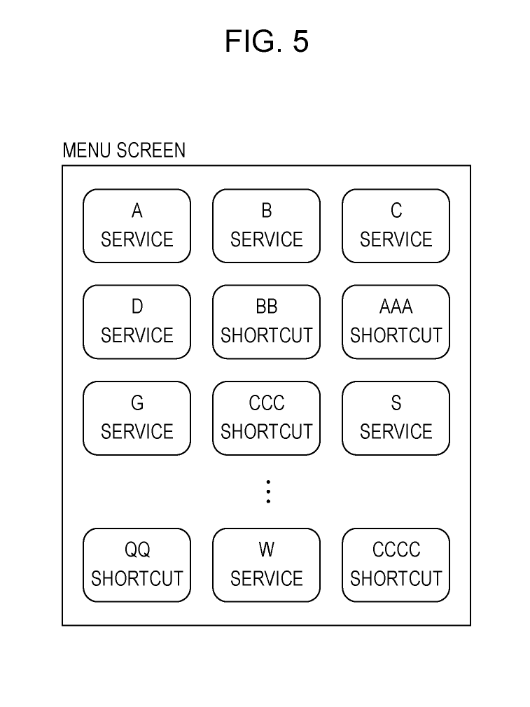

After the menu screen has been displayed on the operation panel 33 in response to a certain operation performed by the user (step 101), the user searches one of the buttons from the menu screen, the button corresponding to a service that is desired to be used by the user. A configuration example of the menu screen is illustrated in FIG. 5. If there are a large number of buttons, it is difficult to display all the buttons on the operation panel 33 at the same time, and thus, the user needs to search a desired button while scrolling the menu screen. In a state where it is difficult to easily find the desired service, the user performs a certain search-execution operation (gesture) on one of the buttons that is displayed on the operation panel 33 and that appears to be related to the desired service. An example of the certain search-execution operation is pressing and holding the button (hereinafter referred to as a pressing and holding operation).

After the operation-receiving unit 11 has received the user operation (step 102), the operation-characteristic-determination unit 12 determines whether the pressing and holding operation has been performed on the button by analyzing the operation received by the operation-receiving unit 11. When the user operation has not been determined to be the pressing and holding operation and has been determined to be a normal selecting operation (N in step 103), the controller 17 recognizes that the normal selecting operation has been performed, that is, recognizes that a service corresponding the selected button has been selected (step 108). As a result, the controller 17 activates the application-execution unit 15 and instructs the application-execution unit 15 to provide the service by executing the corresponding application.

When the user operation has been determined to be the pressing and holding operation (Y in step 103), the controller 17 activates the display-button-selection-processing unit 13. Once the display-button-selection-processing unit 13 has been activated, the display-button-selection-processing unit 13 acquires all the service information items registered in the service-information memory 21 (step 104). Subsequently, the display-button-selection-processing unit 13 extracts in the following manner a service that is related to the desired service on the basis of the service information item corresponding to the selected button (step 105).

First, the display-button-selection-processing unit 13 acquires an application ID that is included in the identification parameter of the service information item of the selected button. Then, the display-button-selection-processing unit 13 searches the service information items on the basis of the application ID so as to select the service information items each of which has the same application ID as that included in the identification parameter of the service information item of the selected button.

Next, the display-button-selection-processing unit 13 acquires a parameter name that is included in the startup parameter of the service information item of the selected button. Then, the display-button-selection-processing unit 13 searches the service information items on the basis of the parameter name so as to select the service information items each of which has a parameter name the same as that included in the startup parameter of the service information item of the selected button.

The services identified by the corresponding service information items that have been extracted in the manner described above are treated as services related to the service that is associated with the selected button, and the display controller 14 generates the related-service display screen on which the buttons corresponding to the extracted service information items are displayed and causes the related-service display screen to be displayed on the operation panel 33 (step 106).

The processes of steps 104 to 106, which have been described above, will be described using a specific example.

For example, assume that a user performs the pressing and holding operation on the “Scan” button, which is displayed on the menu screen and assumed by the user to be related to a desired service (e.g., “ScanToMail”). Here, the “Scan” service is not the desired service. In the case where the scanning services include “Scan”, “ScanToMail”, “ScanToFax”, and “ScanToServer”, the display-button-selection-processing unit 13 performs a search operation on the basis of the application ID included in the service information item of the “Scan” service so as to extract “ScanToMail”, “ScanToFax”, and “ScanToServer” as related services. In addition, in the case where, the parameter name “document size” is set as a parameter name included in the startup parameter of the service information item of the “Scan” service, the display-button-selection-processing unit 13 performs a search operation on the basis of this parameter name so as to extract an S service, a ScanToFax001 shortcut, a ScanToMail005 shortcut, and a ScanToServer001 shortcut, which are services each having a startup parameter that includes the same parameter name as that included in the startup parameter of the service information item of the “Scan” service. The display-button-selection-processing unit 13 performs a grouping operation on the services extracted in the manner described above by classifying the services into categories (the application ID and the parameter name “document size” of the “Scan” service in the above example).

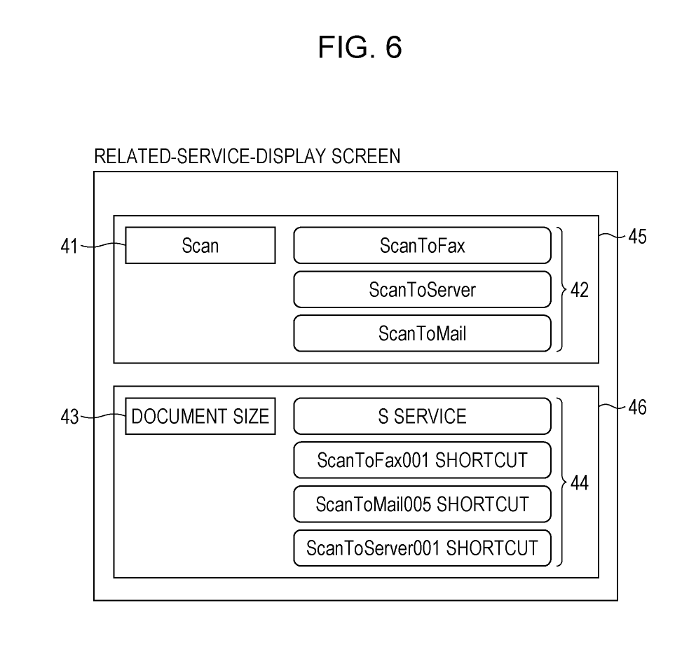

After that, the display controller 14 generates the related-service display screen and causes the buttons for running the extracted services to be displayed on the operation panel 33. A display example of the related-service display screen is illustrated in FIG. 6. As illustrated in FIG. 6, buttons 42 that are associated with services for each of which an application ID is set, the application ID being the same as that of the service (“Scan” in this example), which is associated with a button 41 that has been selected by the user, are displayed in such a manner as to correspond to the button 41. Similarly, buttons 44 that are associated with services for each of which a parameter name is set, the parameter name being the same as the parameter name (“document size” in this example) included in the startup parameter that is set for the service information item of a button 43 that has been selected by the user, are displayed in such a manner as to correspond to the button 43. In this manner, each of the extracted services is displayed in such a manner as to belong to one of groups 45 and 46 each corresponding to a specific category item.

Note that, in the present exemplary embodiment, although the processing that is performed by using only one parameter name (“document size” in the above example) included in the startup parameter as a category item has been described for convenience of description, related services may be extracted for all the parameter names included in the startup parameter. For example, the service information items are searched by using the parameter name “color mode” included in the startup parameter of the “Scan” service. In this case, there is a possibility that buttons different from those extracted when using the parameter name “document size” may be extracted.

Alternatively, the service information items may be searched not on the basis of a parameter name but on the basis of a parameter value. In the present exemplary embodiment, the parameter name is used instead of the parameter value because the “Scan” service is not a service that is desired by the user. That is to say, it is assumed that searching a service having a parameter value the same as the parameter value set for the “Scan” service is not useful. In contrast, the desired service executes an application that is similar to or the same as the application executed by the “Scan” service, and thus, even if the parameter that is passed to the application executed by the desired service has a parameter value that is different from that of the parameter value passed to the application executed by the “Scan” service, it is very likely that the parameter passed to the application executed by the desired service has a parameter (name) the same as that of the parameter passed to the application executed by the “Scan” service. Therefore, in the present exemplary embodiment, the parameter name is used instead of the parameter value. From this standpoint, instead of extracting services on a startup parameter-by-startup parameter basis, a service that has a startup parameter all of whose parameter names are the same as those included in the startup parameter set for the desired service may be extracted, that is, the extracting operation may be performed not under an OR condition but under an AND condition.

After the display controller 14 has generated the related-service display screen and caused the related-service display screen to be displayed on the operation panel 33 in the manner described above, the user selects the button corresponding to the desired service among the buttons displayed on the related-service display screen. Once the user has selected the button, the operation-receiving unit 11 receives this user operation (step 107). The operation-characteristic-determination unit 12 determines whether the user operation is the pressing and holding operation performed on the button. Since the user operation is a normal service-selection operation, the controller 17 recognizes that the service corresponding to the selected button has been selected (step 108). Then, the controller 17 activates the application-execution unit 15 and instructs the application-execution unit 15 to provide the service by executing the corresponding application.

In the above-described processing, each time the pressing and holding operation is performed, the display-button-selection-processing unit 13 searches the service information items, finds services that are related to the service corresponding to a selected button, performs a grouping operation, and causes the services to be displayed. The results of the grouping operation performed after extracting the services may be stored in the grouping-information memory 22 as grouping information. That is to say, the display-button-selection-processing unit 13 causes the results of the processing in step 105 to be stored in the grouping-information memory 22.

For example, if there is grouping information, a button indicating the use of the grouping information is displayed beforehand on the menu screen. When a user intends to use the grouping information, the user presses the button beforehand so as to select the use of the grouping information. Then, when the user performs the pressing and holding operation on a button corresponding to a service that is related to a desired service, if the grouping information corresponding to the service, which has been selected as a result of the user performing the pressing and holding operation on the corresponding button, has been stored in the grouping-information memory 22, the display-button-selection-processing unit 13 will not search the service information items and causes the buttons corresponding to services that are related to the selected service to be displayed on the related-service display screen by using the grouping information.

Note that availability of the grouping information may be determined in accordance with a user ID. In other words, when the display-button-selection-processing unit 13 causes the grouping information to be registered in the grouping-information memory 22, the display-button-selection-processing unit 13 may register a log-in ID (user ID) used when logging in the image forming apparatus 10 so as to be associated with the grouping information such that the grouping information becomes available only when a user who has the registered user ID performs the pressing and holding operation.

In the above-described example, although the button indicating the use of the grouping information is displayed on the menu screen, without preparing an additional button, a certain search-execution operation other than the operation (pressing and holding operation) that instructs the search for related services may be assigned beforehand to the use of the grouping information.

In the present exemplary embodiment, although normal service buttons and shortcut buttons are treated so as not to be distinguished from one another, only the shortcut buttons may be displayed on the related-service display screen. In this case, only services each of which shows a “TRUE” result when referencing the shortcut flag included in each of their service information items may be extracted. This is because a shortcut button is generated by setting parameters beforehand for a service function that is frequently used by a user, and accordingly, it is very likely that such a shortcut button is selected by a user. Alternatively, it is obvious that the buttons excluding the shortcut buttons may be displayed on the related-service display screen.

As described above, in the present exemplary embodiment, services that are related to a selected service are extracted and grouped by effectively using the set contents of existing service information items. However, the related services may be intentionally grouped beforehand. In other words, for example, when generating a shortcut, data (identification information) required for grouping related services may be generated and set as a parameter for each of the service information items of the related services. In this case, the setting-processing unit 16 receives the generated parameter and sets the parameter to each of the appropriate service information items stored in the service-information memory 21. Although such data (identification information) is basically similar to the application IDs included in the identification parameters, the application IDs depend on applications to be executed, and thus, it is difficult to artificially manage a group configuration. On the other hand, the above operation is an operation to be performed by a developer in order to intentionally grouping the related services by setting a parameter that indicates group identification information for each of the service information items of the related services. In other words, instead of performing operations such as those illustrated in FIG. 6, the operations including identification of services, a search operation using only a parameter related to service run, and a grouping operation, information required for the grouping operation may be incorporated beforehand into the service information items, and a service group may be formed by using the information. For example, a group may be formed of services that are used in the same project. Note that, a group that is intentionally formed may be displayed at the start of the search results illustrated in FIG. 6.

Although, in the present exemplary embodiment, the image forming apparatus 10 has been described as an example of an apparatus that provides service functions to a user, such an apparatus need not be an image forming apparatus and may be an information processing apparatus that is configured to realize the above-described processing capabilities.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquiring unit that acquires service information items each of which is set to a corresponding one of display components, which are displayed on a service-selection screen and selected when running services, and each of which includes parameter values set for the corresponding service;
an extracting unit that refers to one of the service information items which is associated with one of the display components selected on the service-selection screen as a result of performing a certain search-execution operation and that extracts services related to the one of the services; and
a display controller that performs control in such a manner that the display components that are to be selected for running the extracted services are displayed on a related-service display screen.

2. The information processing apparatus according to claim 1,
wherein each of the service information items includes, as one of the parameter values, group identification information of a group to which the corresponding service belongs, and
wherein the extracting unit extracts services that belong to a group to which a service that is associated with the selected display component belongs by referencing to the corresponding group identification information.

3. The information processing apparatus according to claim 1, further comprising:
a storing unit that generates grouping information regarding a group of display components for running the services extracted by the extracting unit and causes the grouping information to be stored in a memory,
wherein, when one of the display components is selected on the service-selection screen as a result of performing a certain search-execution operation, the display controller performs control in such a manner that the display components that are included in grouping information generated when the display component has been selected in accordance with an instruction from a user are displayed on the related-service display screen.

4. The information processing apparatus according to claim 1,
wherein each of the service information items includes, as one of the parameter values, a shortcut flag information item that indicates whether the corresponding display component has been generated as a shortcut key, and
wherein the display controller performs control in such a manner that only the display components that have been extracted from the display components for running the extracted services by referencing to the shortcut flag information items and that have been generated as the shortcut keys are displayed on the related-service display screen.

5. The information processing apparatus according to claim 2,
wherein each of the service information items includes, as one of the parameter values, a shortcut flag information item that indicates whether the corresponding display component has been generated as a shortcut key, and
wherein the display controller performs control in such a manner that only the display components that have been extracted from the display components for running the extracted services by referencing to the shortcut flag information items and that have been generated as the shortcut keys are displayed on the related-service display screen.

6. The information processing apparatus according to claim 1, further comprising:
a setting unit that sets identification information of a group for each of the service information items of the services corresponding to the display components that are included in the group.

7. The information processing apparatus according to claim 2, further comprising:
a setting unit that sets identification information of a group for each of the service information items of the services corresponding to the display components that are included in the group.

8. An image forming apparatus comprising:
the information processing apparatus according to claim 1; and
a user-interface unit that displays a screen and receives an operation performed on the screen.

9. An image forming apparatus comprising:
the information processing apparatus according to claim 2; and
a user-interface unit that displays a screen and receives an operation performed on the screen.

10. An image forming apparatus comprising:
the information processing apparatus according to claim 3; and
a user-interface unit that displays a screen and receives an operation performed on the screen.

11. An image forming apparatus comprising:
the information processing apparatus according to claim 4; and
a user-interface unit that displays a screen and receives an operation performed on the screen.

12. An image forming apparatus comprising:
the information processing apparatus according to claim 5; and
a user-interface unit that displays a screen and receives an operation performed on the screen.

13. An image forming apparatus comprising:
the information processing apparatus according to claim 6; and
a user-interface unit that displays a screen and receives an operation performed on the screen.

14. An image forming apparatus comprising:
the information processing apparatus according to claim 7; and
a user-interface unit that displays a screen and receives an operation performed on the screen.

15. A non-transitory computer readable medium storing a program causing a computer to perform a process, the process comprising:
acquiring service information items each of which is set to a corresponding one of display components, which are displayed on a service-selection screen and selected when running services, and each of which includes parameter values set for the corresponding service;
referencing to one of the service information items which is associated with one of the display components selected on the service-selection screen as a result of performing a certain search-execution operation and extracting services related to the one of the services; and
performing control in such a manner that the display components that are to be selected for running the extracted services are displayed on a related-service display screen.
